(19) United States
(12) Patent Application Publication
(10) Pub. No.: US 2011/0040813 A1
(43) Pub. Date: Feb. 17, 2011

(54) IMAGE FORMING APPARATUS

(75) Inventors: Beniko Oue, Shizuoka (JP); Takao Iwasaki, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/817,330

(22) Filed: Jun. 17, 2010

(30) Foreign Application Priority Data
Aug. 12, 2009 (JP) 2009-187417

(51) Int. Cl. G06F 17/30

(52) U.S. Cl. 707/825; 707/E17.01

(57) ABSTRACT

According to one embodiment, an image forming apparatus includes an importing unit, a setting unit, a display, an input unit, a replacement unit, and a transmitter. The importing unit is configured to import a metadata format file having described process information on an image file. The setting unit is configured to set setting items in which the process information is described as at least one of parameters. The display is configured to display a destination for the image file so as to be selected. The input unit is configured to select the destination and input the setting items in the metadata format file corresponding to the selected destination. The replacement unit is configured to replace at least one of the parameters with details. The transmitter is configured to transmit the metadata format file replaced by the replacement unit to the destination along with the image file.

### CROSS-REFERENCE TO RELATED APPLICATIONS

This application is based upon and claims the benefit of priority from Japanese Patent Application No. 2009-187417, filed Aug. 12, 2009; the entire contents of which are incorporated herein by reference.

### FIELD

Embodiments described herein relate generally to a scan and transmission function of transmitting metadata along with an image file.

### BACKGROUND

In recent years, image forming apparatuses such as MFPs (Multi-Function Peripherals) having a scanner function are increasingly used in connection with solutions transmitting a file describing parameters (metadata) for performing fixed processes to a workflow server along with a scanned image file and executing a desired workflow. For example, when an XML (Extensible Markup Language) file describing a facsimile number of a destination is transmitted to a workflow server (a facsimile server in this case) along with a scanned image, the server converts the received image file into an image in a facsimile format and transmits the converted image to the destination specified by the XML file. A workflow transmitting the image scanned by the MFP to a file server using a scan-to-file function and transmitting data as a text file generated by OCR to a destination specified by the XML file as E-mail may be executed. However, when an image forming apparatus transmits an XML file having necessary information along with an image file to a workflow server, it is necessary to write the metadata as parameters of the XML file to correspond to the workflow server actually performing processes.

The metadata transmitted from the image forming apparatus can be classified into fixed metadata including general-use information of the image forming apparatus such as the model number of the MFP, an IP address, and the time when the image forming apparatus performs the job, and metadata input from the image forming apparatus by a user at the time of performing the job. When the metadata is input by the user, input items are often fixed in the image forming apparatus. To write the metadata so as for an application of the workflow server to analyze the metadata, it is necessary to customize the image forming apparatus and it is necessary to change programs of the image forming apparatus depending on the workflow server to be used.

JP-A-2006-85406 discloses a digital multi-function peripheral acquiring a schema registered to correspond to an application of a network device and generating a command group described in XML using the acquired schema.

However, cost or time is taken to customize the metadata transmitted from the image forming apparatus depending on the workflow server every time. The customization of the metadata is to convert metadata representing scan information such as a destination, the number of pages, and a resolution of a scanned image file and work information such as execution time into a format which can be analyzed by the workflow server. The metadata to be customized includes a name of a tag, selection of elements or attributes, the number of ciphers of data, a description method, and the like.

In many cases, the workflow server is adaptable to working with metadata of an image forming apparatus of another company. Accordingly, it is necessary to newly generate the metadata to be transmitted from the image forming apparatus depending on the workflow server.

In the technique described in JP-A-2006-85406, the software for causing the digital multi-function peripheral to support the schema of the network devices is necessary and the digital multi-function peripheral should treat the schema of the network devices, thereby restricting the schema. Therefore, the problem with generality is not solved yet.

An advantage of some aspects of the invention is that it provides an image forming apparatus which can easily change the format of metadata, which can reflect the change in the user interface, and which can be suitably used for various workflow servers.

### BRIEF DESCRIPTION OF THE DRAWINGS

FIG. 1 is an exemplary perspective view illustrating an appearance of an image forming apparatus according to an embodiment;

FIG. 2 is an exemplary diagram schematically illustrating import and transmission of data in the image forming apparatus according to the embodiment;

FIG. 3 is an exemplary block diagram illustrating data transmission using a scan-to-email function or a scan-to-file function in the image forming apparatus according to the embodiment;

FIG. 4 is an exemplary block diagram illustrating the import of an XML format file in the image forming apparatus according to the embodiment;

FIG. 5 is an exemplary diagram illustrating a screen for setting an extended field of the XML format file according to the embodiment;

FIG. 6 is an exemplary diagram illustrating a screen for setting pull-down items according to the embodiment;

FIG. 7 is an exemplary diagram illustrating a screen for setting the pull-down items according to the embodiment;

FIG. 8 is an exemplary diagram illustrating a screen for setting the pull-down items according to the embodiment;

FIG. 9 is an exemplary diagram illustrating a screen for performing a meta-scanning operation according to the embodiment;

FIG. 10 is an exemplary diagram illustrating a screen for selecting a specific template group according to the embodiment;

FIG. 11 is an exemplary diagram illustrating a screen for inputting an extended field developed on a control panel according to the embodiment;

FIG. 12 is an exemplary diagram illustrating a screen for inputting a numerical value according to the embodiment;

FIG. 13 is an exemplary diagram illustrating a screen for inputting a name according to the embodiment;

FIG. 14 is an exemplary diagram illustrating a screen for selecting a place according to the embodiment;

FIG. 15 is an exemplary diagram illustrating a screen for selecting a destination of E-mail according to the embodiment;

FIG. 16 is an exemplary diagram illustrating a screen for inputting a password according to the embodiment;

FIG. 17 is an exemplary diagram illustrating a screen for inputting a date according to the embodiment;

FIG. 18 is an exemplary diagram illustrating an example of an XML format file according to the embodiment;

FIG. 19 is an exemplary diagram illustrating an example of an XML file according to the embodiment;

FIG. 20 is an exemplary diagram illustrating another example of an XML format file according to the embodiment;

FIG. 21 is an exemplary diagram illustrating another example of an XML file according to the embodiment; and

FIG. 22 is an exemplary block diagram illustrating a control system of the image forming apparatus according to the embodiment.

### DETAILED DESCRIPTION

In general, according to one embodiment, an image forming apparatus includes a reading unit, an importing unit, a setting unit, a display, an input unit, a replacement unit, and a transmitter. The reading unit is configured to read an original image and generate an image file. The importing unit is configured to import a metadata format file having described process information on the image file. The setting unit is configured to set, for the metadata format file, setting items in which the process information is described as at least one of parameters. The display is configured to display a destination for the image file so as to be selected at the time of transmitting the image file. The input unit configured to select the destination displayed by the display and input the setting items in the metadata format file corresponding to the selected destination. The replacement unit is configured to replace at least one of the parameters of the setting items in the metadata format file with details input from the input unit. The transmitter is configured to transmit the metadata format file replaced by the replacement unit to the destination selected by the input unit along with the image file.

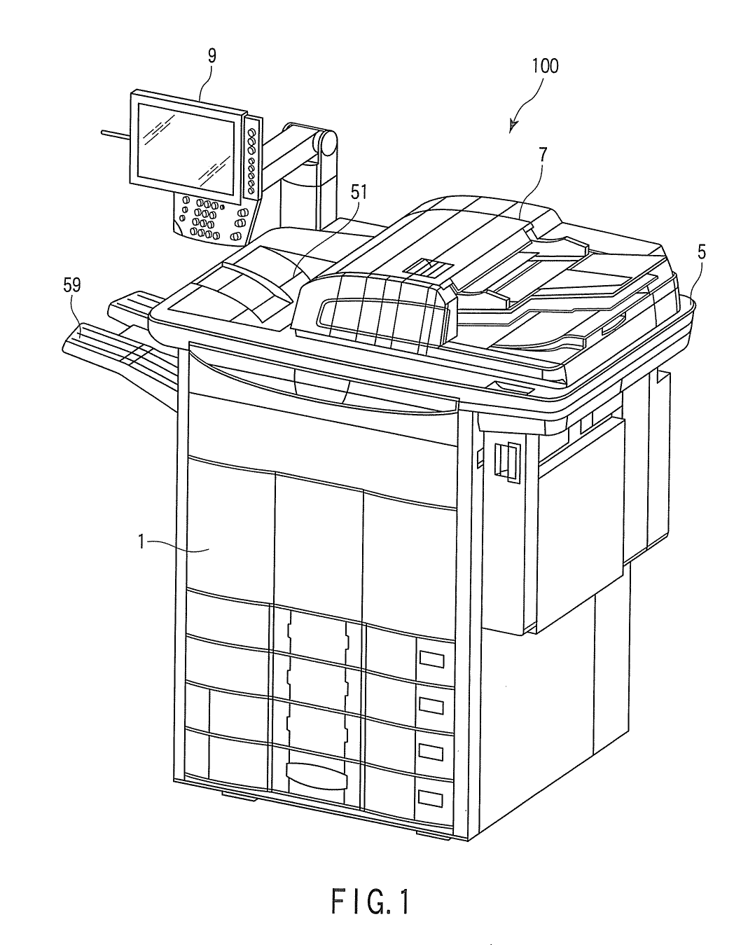

Hereinafter, an embodiment of the invention will be described with reference to the accompanying drawings. FIG. 1 is a perspective view illustrating the appearance of an image forming apparatus 100 (Multi-Function Peripherals) having a scanner function according to the embodiment. The image forming apparatus 100 is, for example, a four unit tandem-type color copier.

The image forming apparatus 100 includes an image forming unit 1 outputting image information as an output image, a cassette 3 feeding sheets of various sizes used to the image output to the image forming unit 1, and a scanner 5 as a reading unit importing data from an original document having image information. An automatic document feeder 7 discharging an original document from a reading position to a discharge position after the scanner 5 reads the image information and guiding a next original document to the reading position when the original document is sheet-like is disposed above the image forming unit 1.

A control panel 9 as an input unit and a display for instructing to start reading image information of an original document by the use of the scanner 5 and instructing other necessary operations is disposed in the image forming apparatus 100.

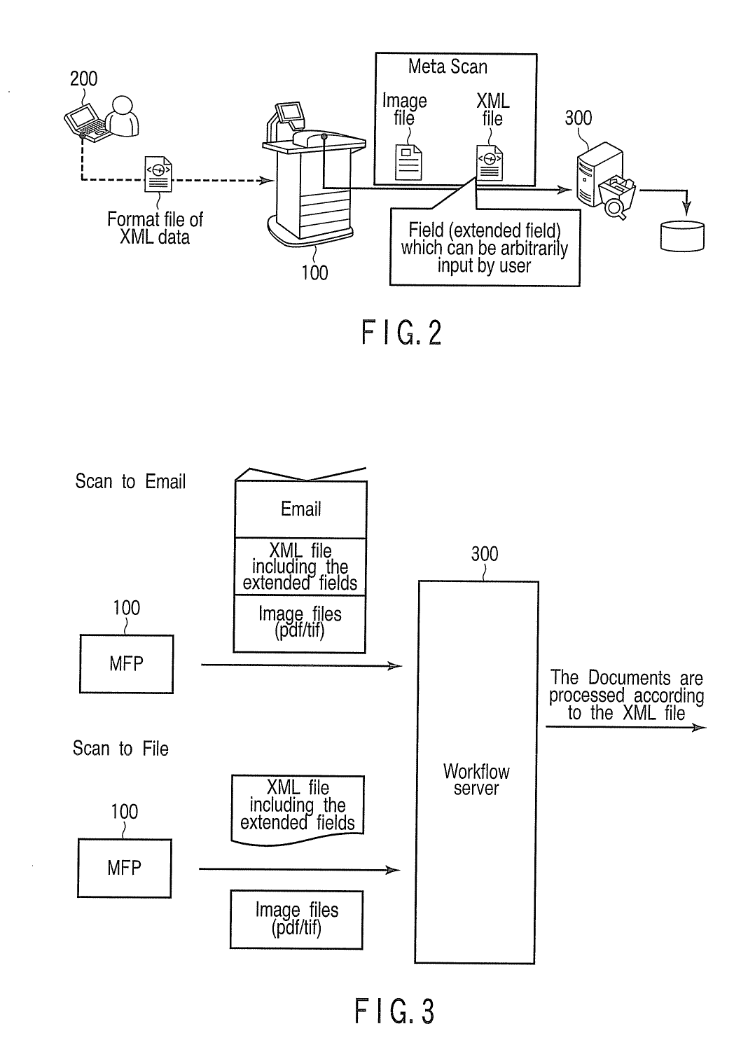

FIG. 2 is a diagram schematically illustrating a state where an XML format file is imported to the image forming apparatus 100 according to the embodiment and an XML file (metadata) is transmitted along with an image file from the image forming apparatus 100. FIG. 22 is a block diagram illustrating a control system of the image forming apparatus 100.

The control system of the image forming apparatus 100 includes a printer unit 10 controlling the image forming unit 1, a scanner unit 15 controlling the scanner 5, the control panel 9 having a liquid crystal display 105 displaying a template selecting screen or a metadata input screen to be described later and a key input unit 106 inputting data or the like, a control unit 101 constituting an importing unit 1011, a setting unit 1012, and a replacement unit 1013 to be described later, a network interface unit 20 being connected to a network and having a receiver 102 and a transmitter 103, a storage unit 104 storing various setting data or image data, and a WEB server 107 providing various setting or registration screens to a PC 200 connected via the network.

When a manager of the image forming apparatus 100 instructs to import an XML format file from the PC 200 connected via the network using the WEB server 107 of the image forming apparatus 100, the importing unit 1011 imports a desired format file among plural XML format files, stored in the PC 200 connected via the network, to the image forming apparatus 100 via the receiver 102.

The manager can additionally generate a meta-scanning template including the XML format file using the WEB server 107 of the image forming apparatus 100. The generation of the meta-scanning template will be described later. Here, the manager generates the template for scanning the metadata from the PC 200 using the WEB server 107 of the image forming apparatus 100, but may generate the template using the control panel 9 of the image forming apparatus 100.

The metadata scanning template can be provided with a field (extended field) into which a user can freely input information to be contained in the XML file at the time of transmission. The manager can set the metadata scanning template for each template group. The template groups correspond to a workflow server 300. The manager may set plural metadata scanning templates for each template group depending on the applications. The control unit 101 stores the metadata scanning templates in the storage unit 104 as the memory unit in correlation with the set XML files.

When the user selects the transmission of the meta-scanning template using the scan-to-Email function or the scan-to-file function, the control unit 101 transmits the XML file along with the image file to the workflow server 300 of the SMTP (Simple Mail Transfer Protocol) or the FTP/SMB (File Transfer Protocol/Server Message Block) via the transmitter 103. The meta-scanning template includes general template setting items and setting items of the XML format file which is a source of the XML file to be added at the time of transmitting the image file.

FIG. 3 is a functional block diagram illustrating the data transmission of the workflow server 300 when the scan-to-Email function or the scan-to-file function is used in the image forming apparatus 100. The image forming apparatus 100 transmits detailed settings on the Email transmission, the XML file including the extended fields, and the scanned image as an image file of pdf or tif to the workflow server 300 when the scan-to-Email function is used.

Similarly, the image forming apparatus 100 transmits the XML file including the extended fields and the scanned image as an image file of pdf or tif to the workflow server 300 when the scan-to-file function is used. The workflow server 300 processes the image file on the basis of the XML file included in the received meta-scanning template.

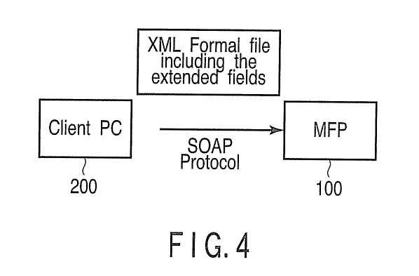

FIG. 4 is a functional block diagram illustrating the importing of the XML format file to the image forming apparatus 100. The manager imports the XML format file including the extended fields to the image forming apparatus 100 via the receiver 102 from the PC 200 using the SOAP (Simple Object Access Protocol).

FIG. 5 is a diagram illustrating a screen for setting the extended fields of the XML format file. The extended field setting screen is displayed on the PC 200 by using the WEB server 107 described above and predetermined inputs from the manager. The extended fields allow the manager to set (newly generate or edit) items for requesting a user for information input when an image file is transmitted to the workflow server 300 from the image forming apparatus 100 using the scan-to-Email function or the scan-to-file function. The setting unit 1012 sets the request items on the basis of the manager's input to the PC 200.

The items of the extended fields will be described below. The extended fields may include items other than the items described below. A setting item name is input to the column of display. The column of mandatory input is marked depending on whether the item name should be necessarily input by a user. The setting unit 1012 determines whether the item is a essential item. The column of hidden attribute is marked depending on whether the attribute of the item name should be displayed.

In the column of input method, an input method of information on the item by a user is selected and marked. In the column of input method, numerical, decimal, text, pull down, address, password, and date can be selected as candidates. The candidate of numerical allows a user to input numerals. The candidate of decimal allows a user to input numerals, alphabets, “.”, and “,”. The candidate of text allows a user to input numerals and alphabets. The candidate of pull down allows a user to select one from a choice set in advance in the selection column. The candidate of address allows a user to select an address with reference to a list of addresses stored in the storage unit 104 of the image forming apparatus 100. The candidate of password allows a user to input numerals and alphabets and displays a password in “*” on the control panel 9 at the time of actual input. The candidate of date allows a user to input a date for the item.

When “pull down” is selected as the input method, a choice to be displayed as a selection column on the control panel 9 is input to the column of pull down items. For example, when “numerical” is selected as the input method, the minimum number of ciphers in the item is input to the column of minimum length. For example, when “numerical” is selected as the input method, the maximum number of ciphers in the item is input to the column of maximum length.

For example, when “numerical” is selected as the input method, the minimum value in the item is input to the column of minimum value. For example, when “numerical” is selected as the input method, the maximum value in the item is input to the column of maximum value. A value to be displayed as a default value of the item is input to the column of default value.

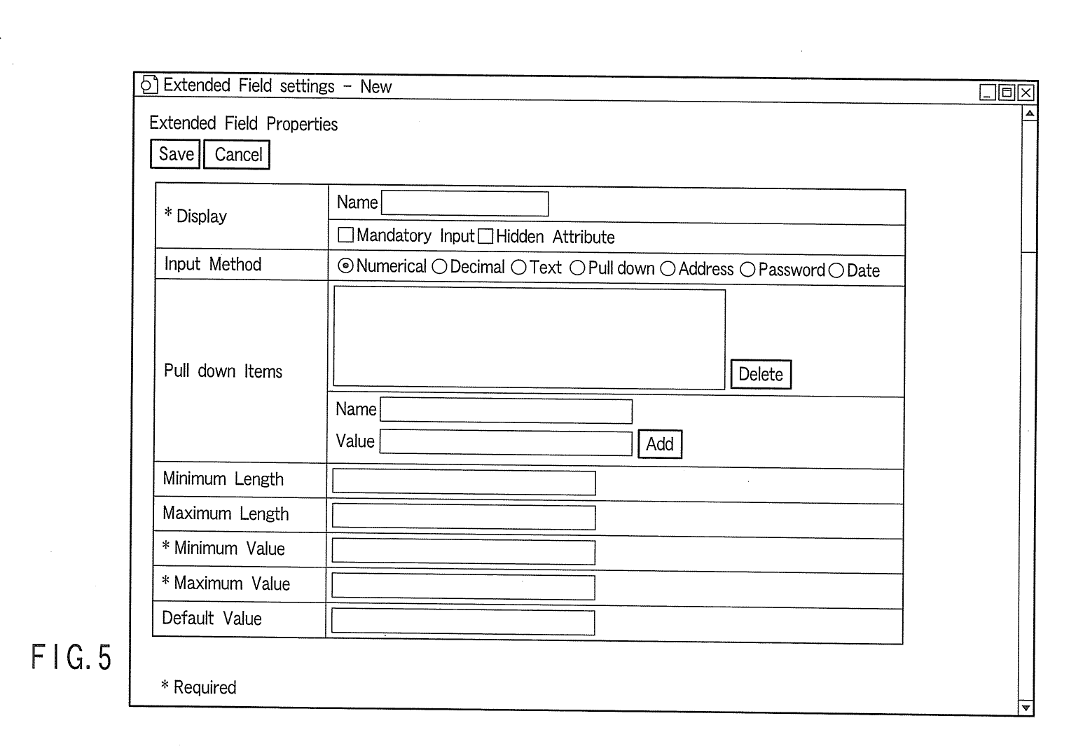

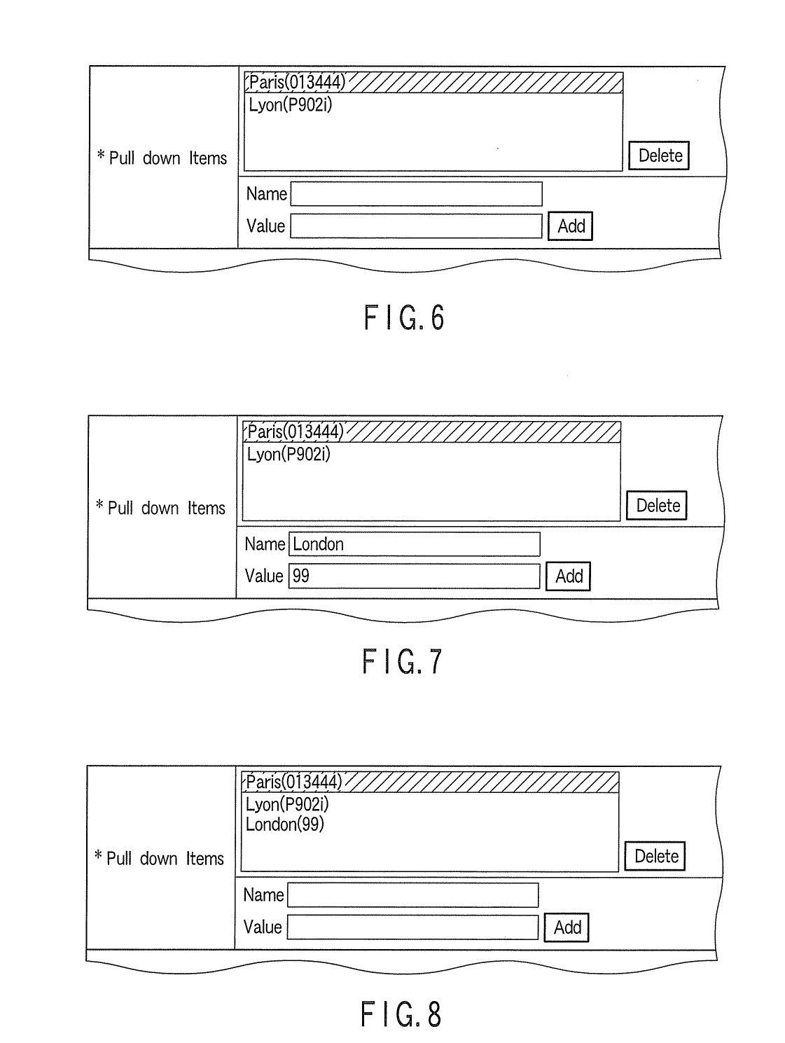

FIGS. 6, 7, and 8 are diagrams illustrating a screen for setting the items of pull down. When the manager selects “pull down” as the input method, the predetermined choice shown in FIG. 6 is displayed in the PC 200. When the manager intends to newly add a choice, the name and the value are input in the PC 200 as shown in FIG. 7. When the manager pushes the button of add, the choice is added as shown in FIG. 8.

The XML format file including the extended fields set as described above is stored as a template of each workflow server in the storage unit 104.

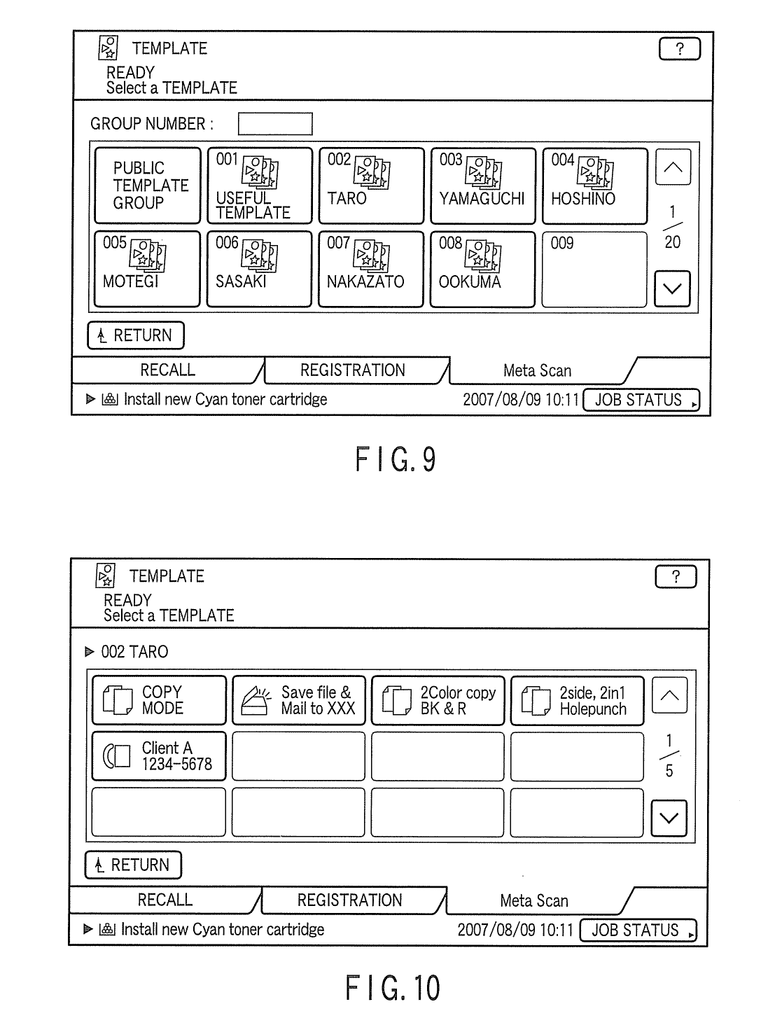

FIG. 9 is a diagram illustrating a screen for performing a meta-scanning operation on the control panel 9. Plural templates may be managed as one group and plural templates may be prepared for each user, each function, or each workflow server. FIG. 10 is a diagram illustrating a screen for selecting a specific template group. FIG. 10 is a diagram illustrating a state where a user selects and pushes a template group in the state shown in FIG. 9 and inputs numerals.

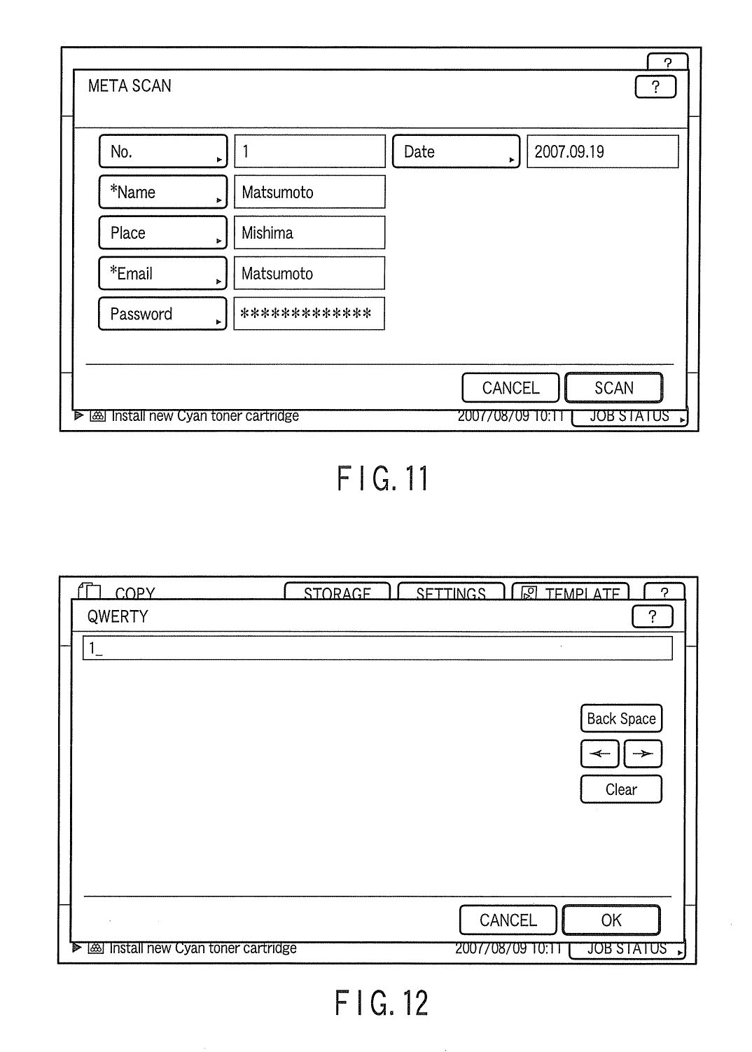

FIG. 11 is a diagram illustrating a screen for inputting the extended fields displayed on the control panel 9 when the specific template is selected. Here, the input items set on the extended field setting screen shown in FIG. 5 by the manager include a number (No.), a name, a place, a destination of Email (Email), a password, and a date of the XML file to be transmitted by performing the scan-to-Email function. When a user inputs all the necessary input items marked by “*” among the input items, a scan operation can be carried out. When the user starts the scan operation, the control unit 101 acquires image data by the use of the scanner 5 and transmits the XML file along with the image file as a meta-scanning template. Here, the name and the destination of Email are marked by “*”.

Here, the input item of number is set to “numerical” in the input method shown in FIG. 5. The input item of name is set to “decimal” or “text” in the input method shown in FIG. 5. The input item of place is set to “pull down” in the input method shown in FIG. 5. The input item of the destination of Email is set to “address” in the input method shown in FIG. 5. The input item of password is set to “password” in the input method shown in FIG. 5. The input item of date is set to “date” in the input method shown in FIG. 5.

FIG. 12 is a diagram illustrating a number input screen. When the user selects the input item of number in the extended field input screen shown in FIG. 11, the number input screen shown in FIG. 12 is displayed on the control panel 9. The user can input a desired number using the numerical keypad of the control panel 9.

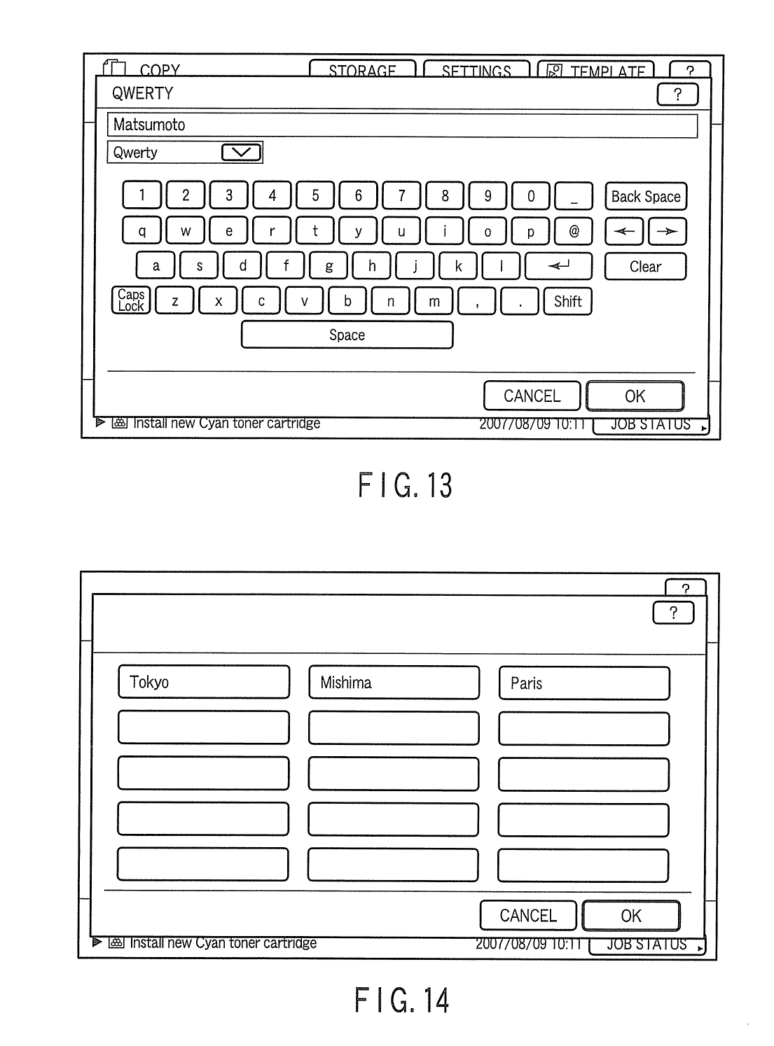

FIG. 13 is a diagram illustrating a name input screen. When the user selects the input item of name in the extended field input screen shown in FIG. 11, the name input screen shown in FIG. 13 is displayed on the control panel 9. The user can input a desired name using the control panel 9.

FIG. 14 is a diagram illustrating a place selecting screen. When the user selects the input item of place in the extended field input screen shown in FIG. 11, the place selecting screen shown in FIG. 14 is displayed on the control panel 9. The user can select a desired place in the choice displayed on the control panel 9.

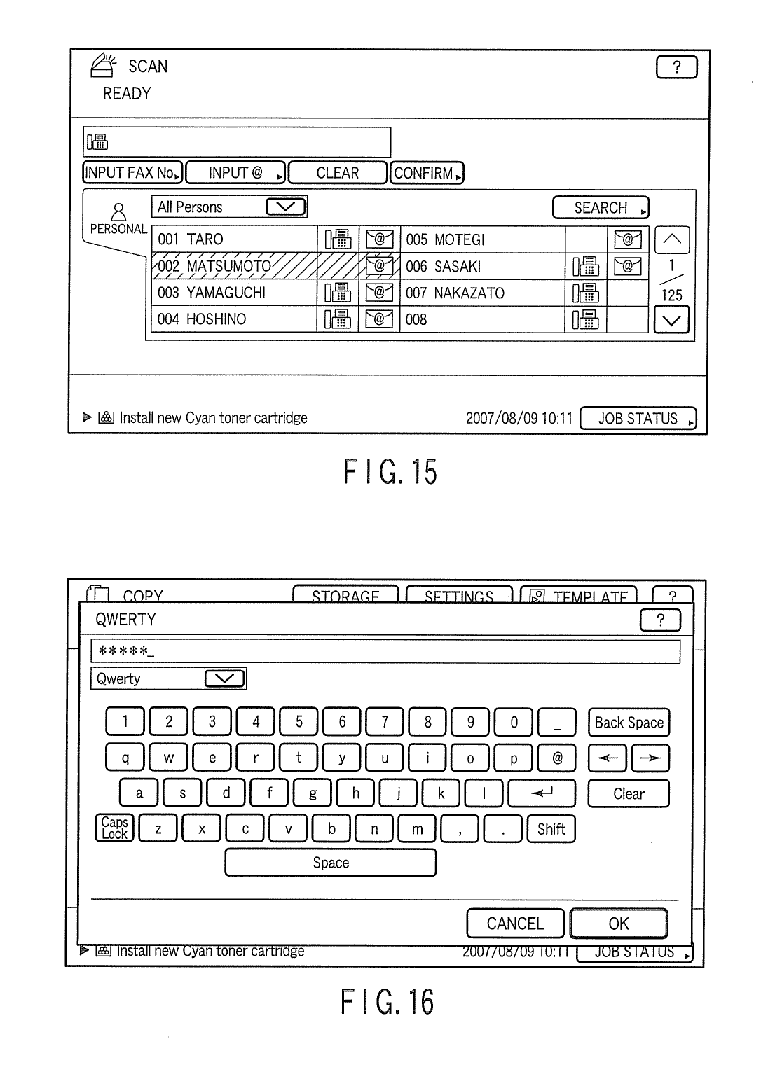

FIG. 15 is a diagram illustrating an Email destination selecting screen. When the user selects the input item of Email destination in the extended field input screen shown in FIG. 11, the Email destination selecting screen including the list of addresses shown in FIG. 15 is displayed on the control panel 9. The user can select a desired Email destination with reference to the list of addresses displayed on the control panel 9. Here, the Email destinations are exemplified, but phone numbers or facsimile numbers may be used.

FIG. 16 is a diagram illustrating a password input screen. When the user selects the input item of password in the extended field input screen shown in FIG. 11, the password input screen shown in FIG. 16 is displayed on the control panel 9. The user can input a password using the keyboard of the control panel 9.

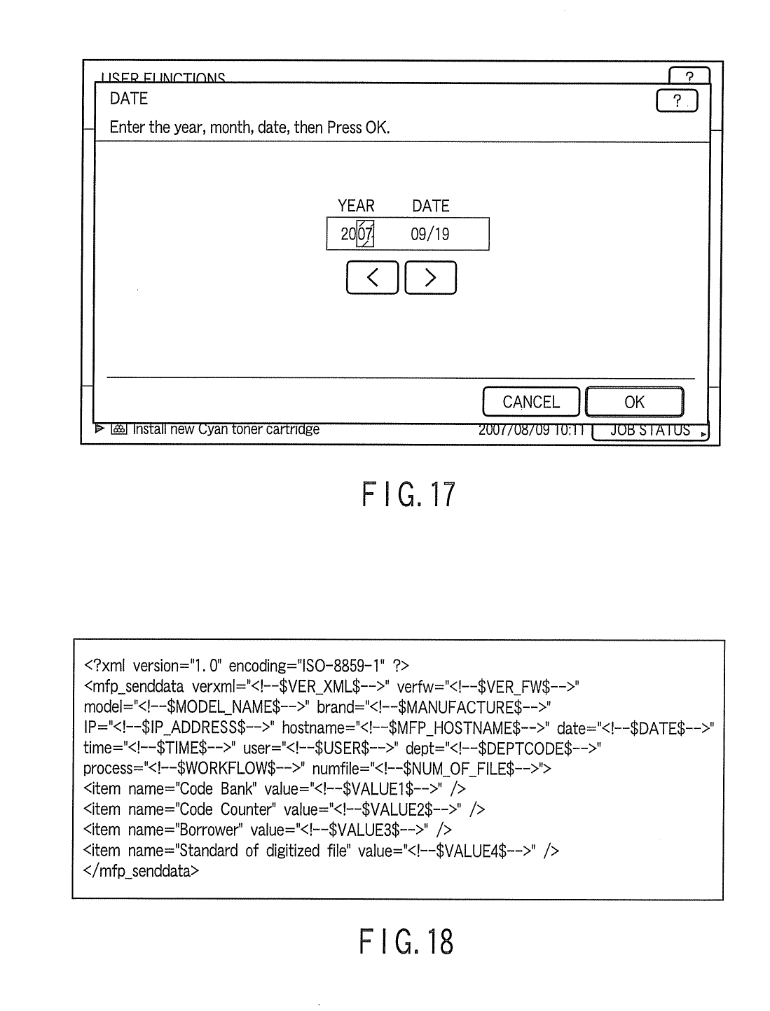

FIG. 17 is a diagram illustrating a date input screen. When the user selects the input item of date in the extended field input screen shown in FIG. 11, the date input screen shown in FIG. 17 is displayed on the control panel 9. The user can input a date using the control panel 9.

FIG. 18 is a diagram illustrating an example of an XML format file set as a specific template. The storage unit 104 of the image forming apparatus 100 stores the template and the XML format file in correlation with each other. In the XML format file, the parts surrounded with “<!--$” and “$-->” are all parameters.

In the XML format file, “<!--$VER_XML$-->”, “<!--$VER_FW$-->”, “<!--$MODEL_NAME$-->”, . . . , and “<!--$NUM_OF_FILE$-->” are all reserved parameter names. That is, the reserved parameters are replaced with information unique to the image forming apparatus 100, which is stored in the storage unit 104 such as a nonvolatile memory or a database.

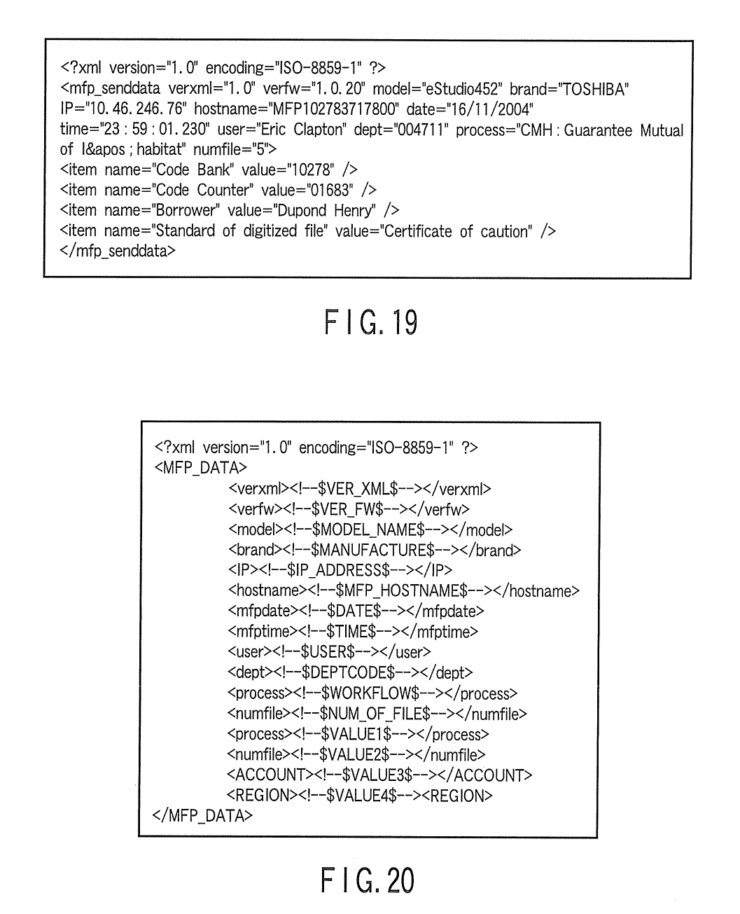

FIG. 19 is a diagram illustrating an example of the XML file included in the meta-scanning template to be transmitted on the basis of the XML format file shown in FIG. 18. The replacement unit 1013 replaces the parameters with the information unique to the image forming apparatus 100 and the actual values input by the user in the form of the XML format file, and generates an XML file to be transmitted along with the image file as the meta-scanning template.

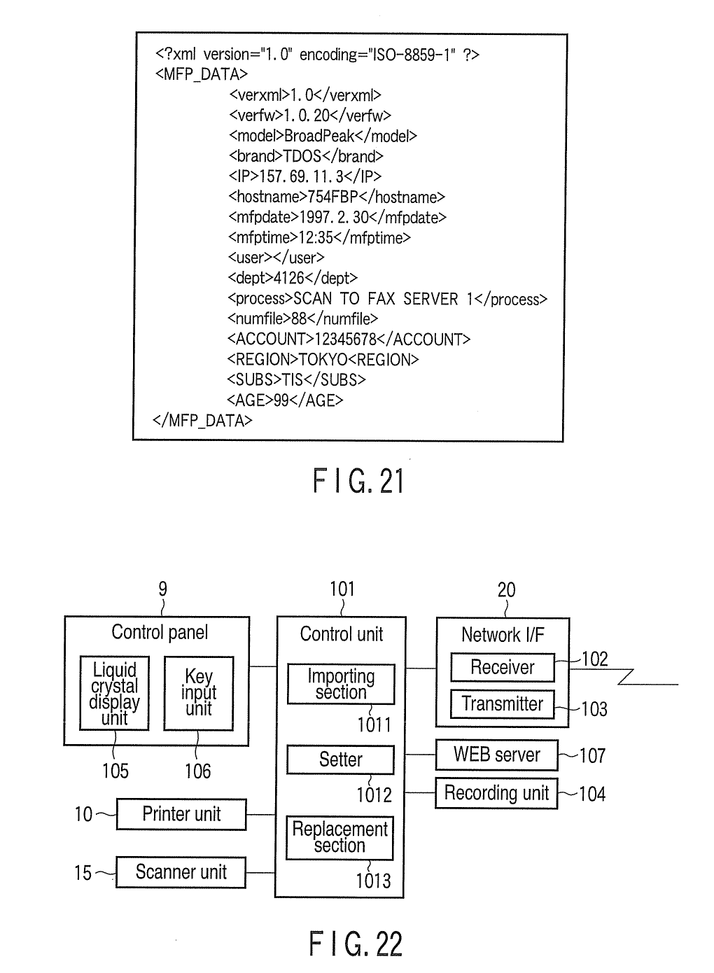

FIG. 20 is a diagram illustrating another example of the XML format file set as a specific template. FIG. 21 is a diagram illustrating another example of the XML file included in the meta-scanning template to be transmitted on the basis of the XML format file shown in FIG. 20. In this case, the control unit 101 replaces the parameters with the information unique to the image forming apparatus 100 and the actual values input by the user in the form of the XML format file, and generates an XML file to be transmitted along with the image file as the meta-scanning template.

According to the above-mentioned embodiment, the manager can generate a necessary XML format file for each workflow. The image forming apparatus 100 simply replaces the text strings described as parameters of the XML format file with the values input by the user or the parameters determined in the job, and transmits the replaced values or parameters to the workflow server 300. Therefore, since this method is very intuitive, a network manager which is poor at the XML can cope with the method. According to the above-mentioned embodiment, the image forming apparatus can easily change the metadata format for a workflow and can reflect the change in the user interface. Accordingly, the resultant metadata can be suitably used in various workflow servers.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image forming apparatus comprising:
a reading unit configured to read an original image and generate an image file;
an importing unit configured to import a metadata format file having described process information on the image file;
a setting unit configured to set, for the metadata format file, setting items in which the process information is described as at least one of parameters;
a display configured to display a destination for the image file so as to be selected at the time of transmitting the image file;
an input unit configured to select the destination displayed by the display and input the setting items in the metadata format file corresponding to the selected destination;
a replacement unit configured to replace at least one of the parameters of the setting items in the metadata format file with details input from the input unit; and
a transmitter configured to transmit the metadata format file replaced by the replacement unit to the destination selected by the input unit along with the image file.

2. The apparatus of claim 1, further comprising a storage unit configured to store the metadata format file in correlation with the destination.

3. The apparatus of claim 1, wherein the setting unit is configured to set whether an item input from the input unit among the setting items is an essential item and the transmitter is configured to transmit the image files when all the essential items are input.

4. The apparatus of claim 1, wherein the setting unit is configured to set a plurality of different metadata format files for a workflow server.

5. The apparatus of claim 1, wherein the setting unit is configured to set a metadata format file for each workflow server.

6. The apparatus of claim 1, wherein the importing unit is configured to import the metadata format file using a simple object access protocol.

7. The apparatus of claim 1, wherein the replacement unit is configured to replace items other than the setting items included in the metadata format file with details unique to the image forming apparatus.

8. An image forming system comprising:
a reading unit configured to read an original image and generate an image file;
an importing unit configured to import a metadata format file having described process information on the image file;
a setting unit configured to set, for the metadata format file, setting items in which the process information is described as at least one of parameters;
a display configured to display a destination for the image file so as to be selected at the time of transmitting the image file;
an input unit configured to select the destination displayed by the display and input the setting items in the metadata format file corresponding to the selected destination;
a replacement unit configured to replace at least one of the parameters of the setting items in the metadata format file with details input from the input unit; and
a transmitter configured to transmit the metadata format file replaced by the replacement unit to the destination selected by the input unit along with the image file.

9. The system of claim 8, further comprising a storage unit configured to store the metadata format file in correlation with the destination.

10. The system of claim 8, wherein the setting unit is configured to set whether an item input from the input unit among the setting items is an essential item and the transmitter is configured to transmit the image files when all the essential items are input.

11. The system of claim 8, wherein the setting unit is configured to set a plurality of different metadata format files for a workflow server.

12. The system of claim 8, wherein the setting unit is configured to set a metadata format file for each workflow server.

13. The system of claim 8, wherein the importing unit is configured to import the metadata format file using a simple object access protocol.

14. The system of claim 8, wherein the replacement unit is configured to replace items other than the setting items included in the metadata format file with details unique to the image forming apparatus.

15. A data transmitting method in an image forming apparatus for reading an original image and generating an image file, the method comprising:
importing a metadata format file having described process information on the image file;
setting, for the metadata format file, setting items in which the process information is described as at least one of parameters;
displaying a destination for the image file so as to be selected at the time of transmitting the image file;
replacing at least one of the parameters of the setting items in the metadata format file corresponding to the selected destination with input details; and
transmitting the replaced metadata format file to the selected destination along with the image file.

16. The method of claim 15, further comprising transmitting the files when all essential items among the setting items are input.

17. The method of claim 15, further comprising setting a plurality of different metadata format files for a workflow server.

18. The method of claim 15, further comprising setting a metadata format file for each workflow server.

19. The method of claim 15, further comprising importing the metadata format file using a simple object access protocol.

20. The method of claim 15, further comprising replacing items other than the setting items included in the metadata format file with details unique to the image forming apparatus.
